(19) United States
(12) Patent Application Publication
(10) Pub. No.: US 2003/0106155 A1
(43) Pub. Date: Jun. 12, 2003

(54) Inflatable stretcher

(76) Inventor: Lisa Arai, Chicago, IL (US)

Correspondence Address: RICHARD C. HIMELHOCH, 311 S. WACKER DRIVE, 53RD FLOOR, CHICAGO, IL, 60606-6622, US

(21) Appl. No.: 10/020,500

(22) Filed: Dec. 12, 2001

(51) Int. Cl. A61G 1/013

(52) U.S. Cl. 5/627; 5/625

(57) ABSTRACT

An device for transporting an injured or disabled person from a building in an emergency situation including a source of pressurized fluid, such as a compressed air canister or cartridge, and an inflatable stretcher connected to the pressurized fluid source. The inflatable stretcher includes one or more handles to allow someone assisting the injured or handicapped person down a stairwell of the building. The stretcher includes means for securing the person to the stretcher, and further include air pockets configured to support, secure and cushion the injured or disabled person.

### TECHNICAL FIELD

The present invention is generally directed to an apparatus for moving or transporting handicapped or injured persons, and more particularly to an inflatable apparatus to assist moving handicapped or injured persons down a stairwell of a building in an emergency situation.

### BACKGROUND OF THE INVENTION

When an emergency situation arises in a multi-storied building, such as a fire or explosion, a required course of action may include evacuating the building. Typically, people evacuating such buildings are warned to avoid using all elevators. Thus, the primary (and sometimes only) option in exiting buildings having two or more stories, is through the stairwell.

While most people have no difficulty exiting a building through the stairwell, those that are injured or handicapped, may have great difficulties in climbing down the stairs. This is especially a concern for those individuals that are unconscious or have limited or no ability to use their legs. Such individuals cannot exit the building on their own and require assistance in evacuating through the stairwell.

Generally, not many individuals have the physical capability to be able to carry an injured or handicapped person down several (or even one) flights of stairs unassisted. Even two individuals would have difficulty navigating a stairwell while carrying such a person. This would require either supporting such a person on either side (i.e., under each arm with all three in an upright position), or having one individual support and carry the lower half of the injured or handicapped person, and the other carry the upper half. In the first instance, the width of the stairwell may limit or inhibit the ability of three individuals to descend it side-by-side. Even if the stairwell was wide enough, the side-by-side approach would inhibit others attempting to descend the stairwell at a faster rate, or those (such as firemen, policemen or other emergency personnel) from climbing up the stairwell to assist others remaining in the building or to deal with the emergency situation (e.g., a fire). The latter approach, however, is awkward given the slope of a stairwell, and tiring in that the injured or handicapped individual must be support above the sharp edges of the stairs and thus the full weight of the individual must be carried. Moreover, in some cases it may be necessary to immobilize the injured or handicapped person (as best as possible) when transporting them down the stairwell. Thus, either method of physically carrying the person may do more harm than good.

Some devices have been developed to assist transporting an injured or handicapped person down a stairwell. For example, it is understood that certain wheelchairs have been developed that are specifically designed to navigate stairs. However, these are costly, and would take a significant amount of storage space, to keep on hand in the case of an emergency. Additionally, such wheelchairs are slow going down a stairwell, and require lifting from one chair to the next. Moreover, they cannot be used when it is necessary to move a person that must be maintained in a prone position. Other techniques advocated in hospitals in the past include using a blanket or a mattress to facilitate moving a person down a stairwell. That is, the injured or handicapped person would be laid on the blanket or mattress, and dragged down the stairwell. Although blankets are cheaper and can be more readily stored than the specially designed wheel chairs, they provide only scant protection against the sharp edges of the stairs. Mattresses may provide more protection against such edges, but are more costly and like the wheelchairs, not readily stored or obtainable in a multi-storied building, especially an office building. While inflatable mattresses are available, it is difficult to secure a disabled person to any type of typical mattress. Moreover, the inflatable mattresses are not designed to withstand being dragged down a flight of stairs.

Accordingly, a need exists to provide a compact device which can be readily stored in any multi-story building, that can assist transporting an injured or handicapped individual out of the building. The present invention meets this need by providing an inflatable stretcher or Gurney, that can be used to carry or pull an injured or handicapped individual quickly down a stairwell and out of a building. The device could be placed, for example, at the entry to each level of the stairwell in a compact, uninflated form, preferable next to or with other emergency equipment such as fire extinguishers, hoses or axes. The device could then be quickly inflated and used to allow an injured or handicapped person be pulled or lifted down the stairs to safety.

### SUMMARY OF THE INVENTION

The present invention provides an apparatus to assist evacuating or moving injured or handicapped (hereafter, “disabled”) persons from a building in an emergency situation. Specifically, the apparatus allows firemen, policemen, paramedics or others assisting in an emergency situation to move the injured or handicapped person down a stairwell. The apparatus may also assist moving the person along a level terrain.

In one embodiment, the invention comprises a device for assisting in transporting a disabled person comprising a compressed fluid cartridge (such as compressed air), and an inflatable stretcher connected to the compressed fluid cartridge. The compressed fluid cartridge can be air or any other suitable fluid, and preferably is one that is non-flammable. The inflatable stretcher includes a first end, a second end opposing the first end, and a first side and a second side opposing the first side to provide a generally rectangular profile. The stretcher may further comprise a first handle connected at the first end of the stretcher, and a second handle connected at the second end of said stretcher. Additionally, a third handle may be connected on the first side of the stretcher, and a second handle may be connected to the second side of said stretcher. The handles enable those assisting the disabled person to carry or drag the stretcher. Additional handles be also be connected at strategic locations around the stretcher. Moreover, the stretcher can be fitted with handles for the disabled person to hold while being transported.

The device may further include at least a first belt for securing the disabled person to the stretcher. Additional belts, e.g. a second or third belt, may also be included.

The inflatable stretcher may include a plurality of fluid containing pockets positioned from the first end to the second end of the stretcher to provide the primary support to the disabled person. Additionally, the pockets cushion and protect the disabled person from further injury from being dragged down the stairwell. Each of the pockets may extend from the first side to the second side of the stretcher. However, a number of configurations or designs of air pockets can be employed.

The stretcher can also be configured with additional pockets specifically designed to provide additional support to certain portions of the body, like the head and neck area. These pockets may contain a fluid like air, or a jelly like substance.

Additionally, the stretcher may further comprise a fluid containing railing extending about the first end, first side, second end and second side. In one embodiment, the railing may extend at least partially over a disabled person supported on the stretcher to help secure and hold the person to the stretcher. In an extreme example, the stretcher may be configured to form almost a cocoon around the disabled person.

The stretcher is preferably formed having an outer surface comprising a non-flammable material. In this regard, the stretcher is formed from a fireproof or fire resistant material, or is treated with a fireproof or fire resistant chemical.

Additionally, the stretcher may include other features like a plurality of wheels connected to a bottom portion of said stretcher. The wheels can be preferably connected so that they can be folded down for use. Such wheels would facilitate movement of the stretcher over level areas. Also, the stretcher may further include an electronic beacon connected to the stretcher, to enable emergency personnel to locate the device if necessary.

The stretcher may further include a sheet securable to the first side and the second side to secure and hold a disabled person to the stretcher. The sheet may be integrally connected to the stretcher, e.g., sewn onto it, or may be detachably connected by a zipper, snaps or velcro.

The device may further be configured with a compartment within the stretcher to support medical equipment. For example, such equipment may include an oxygen supply, or an IV bag.

The stretcher may also include a rigid support connected to a bottom portion of the stretcher. The rigid support may be a sheet of hard plastic. This enables the stretcher to be more easily dragged down a stairwell without risk of rupturing the inflatable portion of the stretcher by the sharp edges of the stairs. Alternatively, other padding or materials may be used on the bottom of the stretcher.

In an alternative embodiment, a device for carrying a disabled person comprising an inflatable stretcher is disclosed. The stretcher includes a first end, a second end opposing the first end, a first side, a second side opposing the first side, a first handle connected proximate the first end, and a second handle connected proximate the second end. Additional handles can be connected to the sides (either in the middle or toward either end of the stretcher). The stretcher may include a compressed air cartridge connected to the stretcher to inflate it. Alternatively or in addition, the stretcher may be provided with a port to allow for manual inflation or use of a pump.

Again, the stretcher may further comprise a belt to secure a disabled person to the stretcher. The belt may include a first belt portion, e.g. a strap, connected to the first side of the stretcher, and a second belt portion to the second side of the stretcher. Alternatively, the belt may have only one strap portion connected to one side that is secured by buckle or other connecter to the other side.

The stretcher may comprise a plurality of fluid containing pockets positioned between the first end and the second end, each pocket extending from the first side to the second side of the stretcher. Additionally, the stretcher may include a first inflated railing portion at the first side extending from the first end to the second end, and a second inflated railing portion at the second side extending from the first end to the second end. The first and second railing portions may extend outward to at least partially surround and enclose a disabled person positioned on the stretcher.

The stretcher may be formed of a flexible fire resistant material. Additionally, the stretcher may include inflatable pockets proximate the second end to support and cushion a head portion of a disabled person, or include a recessed portion when the stretcher is inflated to hold medical equipment for the disabled person. Again, the stretcher may also include a rigid or semi-rigid material, such as a hard plastic sheet, connected to a bottom portion of the stretcher.

The device, when not inflated, is preferably folded to a small size for easily storing the device when not in use. For example, the device can be located with other emergency equipment located in a building, such as in the stairways, or can be mounted on the back of a wheelchair. Additionally, the device could be stored in the trunk of a police car, ambulance, fire truck or other emergency vehicle. Further, the device could be provided with straps so that emergency personnel can carry the device like a backpack, leaving their hands and arms free. The small deflated size makes the device extremely portable.

Further aspects of the invention are disclosed in the detailed description of the preferred embodiment, the drawings and the claims.

### BRIEF DESCRIPTION OF THE DRAWINGS

FIG. 1 is a perspective view of an embodiment of an inflatable stretcher of the present invention prior to inflation;

FIG. 2 is a perspective view of the inflatable stretcher with an injured or disabled person secured in the stretcher;

FIG. 3 is a top plan view of the inflatable stretcher of FIG. 2;

FIG. 4 is a bottom plan view of the inflatable stretcher;

FIG. 5 is an alternative embodiment of the inflatable stretcher of the present invention;

FIG. 6 is a bottom plan view of an alternative embodiment of an inflatable stretcher of the present invention; and

FIG. 7 is an alternative embodiment of an inflatable stretcher of the present invention including an inflated portion that substantially covers a top portion of a disabled person.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

FIG. 1 discloses an inflatable stretcher 10 of the present invention, that is deflated and folded into a compact unit. The stretcher 10, in its deflated form, may be mounted in a stairwell (preferably one or more units at the entrance to each level of the stairwell), or at other strategic locations within a building. For example, the stretcher 10 can also be placed with other emergency equipment commonly found throughout a building, such as fire extinguishers, hoses, axes, first aid kits etc. Additionally, the stretcher can be stored in emergency vehicles, and then carried to the disabled person.

In the embodiment disclosed in FIG. 1, a source of pressurized fluid, in this instance in the form of a compressed air cartridge 12 is connected directly to the main body of the deflated stretcher 10. The compressed air cartridge can be the same or similar to the technology commonly used to self inflate life jackets, rafts, and other self-inflating items. Additionally, the cartridge may contain some other compressed fluid, such as a non-flammable gas. The cartridge 12 may be permanently connected to the stretcher 10, or may be designed to be removed once the main body of the stretcher 10 is inflated and ready for use.

In alternative embodiments of the invention, the stretcher 10 may also include a port for either manual inflation (i.e., an individual personally blowing up the stretcher 10), or to provide a connection to a pump or another compressed air cartridge not originally connected to the stretcher 10. In the future, some buildings utilizing this invention may be constructed with pressurized air lines running through the building to inflate the stretcher 10. This port may also act as a valve to enable the stretcher 10 to be deflated after use.

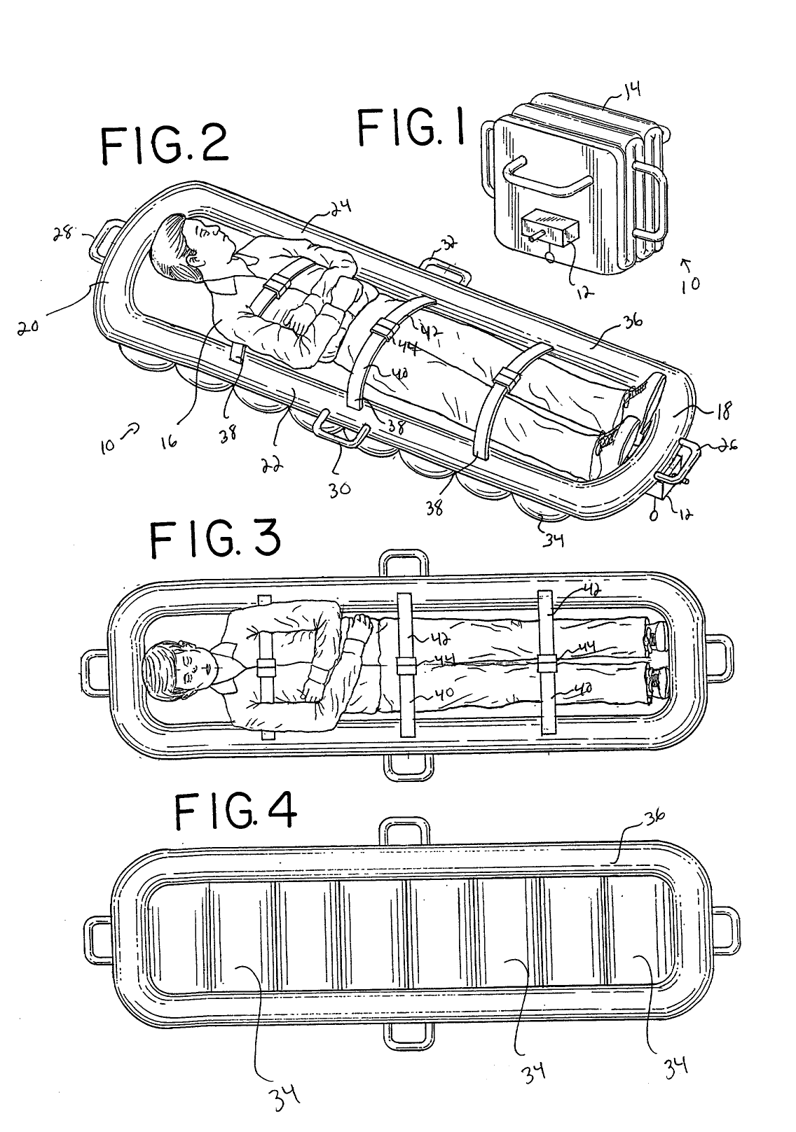

The stretcher 10 is stored in its deflated form at the desired locations throughout a building or other structure, until an emergency situation arises. During an emergency, the stretcher can be removed from its mounting or storage location, and inflated by activating the compressed air cartridge (or by using one of the alternative methods discussed above for an alternative embodiment of the invention). Additionally, the stretcher 10 could include straps to enable an emergency worker to carry it like a back pack (in the stretcher's deflated form) to a disabled person. The compressed air causes the main body 14 of the stretcher 10 to expand into an inflated form as shown in the embodiments of FIGS. 2-7.

FIG. 2 shows an inflated stretcher 10 with a disabled person 16 in a prone position secured to the upper or top surface of the stretcher 10. The main body 14 of the stretcher is preferably formed from a flexible, abrasion resistant material that is either fireproof or fire resistant, or has been treated with a fireproof or fire resistant chemical. It is contemplated that the stretcher 10 will be used to move a disabled person down the stairwell. Accordingly, the material (at least for the bottom portion) should be able to withstand the stretcher being dragged in part, against the sharp edges of the stairs. In an alternative embodiment discussed in more detail below, a special material may be applied to the bottom of the stretcher 10 to ensure that the edges of the stairs do not rupture the stretcher as it is being dragged down the stairwell.

The stretcher 10, as viewed from the top or bottom, has a generally rectangular profile. The stretcher 10 includes a first end 18 where the feet of the disabled person 16 are positioned, and a second end 20 opposing the first end 18, where the head of the disabled person 16 is positioned. Additionally, the stretcher 10 includes a first side 22 and an opposing second side 24.

The stretcher includes a first handle 26 connected to the main body 14 of the stretcher 10 proximate the first end 18, and a second handle 28 connected proximate the second end 20. The handles 26, 28 located proximate the first and second ends 18, 20, respectively, can be used to carry and/or drag the disabled person down a stairwell. Preferable, holding the handle at one of the two ends 18 or 20, one individual will lead the way down the stairwell with another individual holding the other handle. When only one person is available to assist the disabled person 16, the stretcher 10 can be simply dragged down the stairwell using one of the handles 26, 28 at one of the ends 18, 20. Because the stretcher 10 is inflated, the disabled person 16 is protected against injury from the sharp edges of the stairs.

Instead of one handle at each of the two ends 18 and 20, two or more handles can be connected proximate the ends to allow someone carrying the stretcher to more readily use both hands. Alternatively, the single handle could be wide enough to accommodate both hands.

In addition to the handles 26 and 28 at either end of the stretcher 10, a third handle 30 can be connected to the first side 22, and a fourth handle 32 can be connected to the second side 24 of the stretcher 10. These side handles 30, 32 can be utilized to carry the disabled person 16 across level ground. Additionally, more than one handle can be connected to the sides 22, 24. For example, handles can be placed on the sides 22, 24, but closer the first and second ends 18, 20 to allow four people to carry the stretcher 10.

The main body 14 of the stretcher 10 is preferable configured to securely hold the disabled person 16, and to cushion the disabled person 16 against any impact when being evacuated from the building. In this regard, the stretcher 10 (when inflated) includes a plurality of air pockets 34 between the first end 18 and the second end 20 of the stretcher 10 which form the primary support for the disabled person 16. Each of the air pockets 34 extend from the first side 22 to the second side 24 of the stretcher 10, however, other configurations can be used. The air pockets 34 provide a cushioned barrier between the disabled person 16, and the sharp edges of the stairs. Thus, the stretcher can be dragged down the stairs with further injuring the disabled person 16.

In addition to the supporting air pockets 34, the stretcher 10 further includes an inflatable rail 36 that preferable extends along each end 18 and 20 and each side 22 and 24 of the stretcher 10 to completely surround the disabled person 16. Alternatively, the rail 36 may simply extend along each side 22, 24 of the stretcher 10. The rail 36 and supporting air pockets 34 form a well where the disabled person 16 is positioned.

In an alternative embodiment (not shown), the rail (especially those portions along the sides of the stretcher 10) can extend to partially cover and further secure portions of the disabled person. In an extreme example shown in FIG. 7, the stretcher 10 can be configured like a cocoon, wherein the rail 36′ almost completely surrounds the disabled person 16. In this instance, it is advantageous to unfold the stretcher 10 and place the disabled person 16 on the stretcher 10 prior to inflation, allowing the stretcher to form around the disabled person 16 as it inflates.

The stretcher 10 may also include other means to secure the disabled person 16 to the stretcher 10. For example, at least one belt 38 can be attached to the main body 14 of the stretcher 10. In the preferred embodiment disclosed in FIGS. 2 and 3, three belts 38 are shown. The belts can have a first strap portion 40 connected to the first side 22, and a second strap portion 42 connected to the second side 24, that connect to each other over the disabled person 16 by a buckle, velcro or other similar connector 44. Alternatively, the belt may have a single strap portion connected to only one side of the stretcher 10, which can be secured to a buckle or other connector at the other side of the stretcher 10. Additional belts may be provided to specifically hold or stabilize certain areas of the disabled person, such as in the head area, or to hold medical equipment in place. The stabilizing belts may become necessary if the person suffered a head or neck injury.

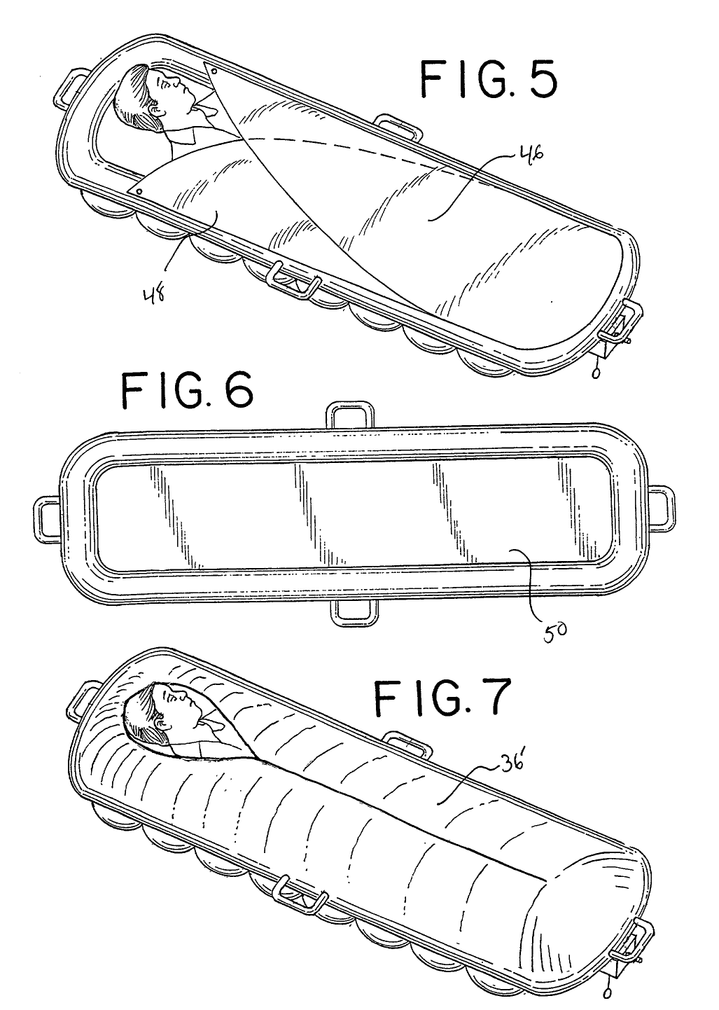

In an alternative embodiment, the stretcher 10 may include a sheet or blanket that covers the upper portion of the disabled person 16. As shown in FIG. 5, two sheet elements 46 and 48, are connected to the rail 36 along the sides 22 and 24 and bottom end 18 of the stretcher 10. The sheets can be sewn or otherwise integrally formed in the stretcher 10, or can be detachably connected by a zipper, snaps, buttons or other conventional means.

Another alternative embodiment of the stretcher 10, shown in FIG. 6, includes a sheet of rigid or semi-rigid material 50 connected to at least a portion of the bottom of the stretcher 10. As shown in FIG. 6, the material extends from the first end to the second end. However, other configurations may be used. For example, a thin piece of hard plastic positioned at the middle portion of the bottom of the stretcher 10 could be utilized. The rigid or semi-rigid sheet 50 will provide a surface against which the edge of the stairs may contact. In this manner, it would be even more difficult to rupture the stretcher 10 when dragging it down the stairwell. Additionally, the sheet 50 may have a lower coefficient of friction than the inflatable material of the stretcher, which would further facilitate transportation down the stairwell.

The stretcher 10, when inflated, is sized to accommodate an average adult. Preferably, the stretcher 10 extends approximately six feet from the first end 18 to the second end 18, and approximately two feet from the first side 22 to the second side 24. However, a smaller version, dimensioned for children or smaller adults, can also be utilized, e.g. four feet from the first end 18 to the second end 20, or larger versions can be utilized for above average sized individuals.

Additional safety features can also be incorporated into the inflatable stretcher 10. For example, the stretcher 10 can be configured to include a cavity or compartment to hold medical equipment for the disabled person 16. This may include oxygen canisters, IV bags etc. Additionally, the stretcher 10 may include additional inflatable pockets to specifically provide further support or to stabilize certain areas of the disabled person, such as the head or neck region. Another safety feature is an electronic beacon device that may help firemen or other emergency personnel, locate the disabled person 16 if necessary.

Other features that may be included are wheels (not shown) connected to the bottom portion of the stretcher 10. In the embodiment including the rigid or semi-rigid sheet, the wheels can be connected to the sheet. The wheels could be similar to those use for in-line skates, skateboards or rolling luggage, and could facilitate moving the disabled person along level areas either inside or outside of the building. Additionally, one of more of the handles may be provided with an extension cord to allow one to drag and/or roll the stretcher 10 from an upright position. That is, the person assisting the disabled person 16 would not necessarily be forced to bend over to grab the handle.

While specific embodiments have been illustrated and described, numerous modifications are possible without departing from the spirit of the invention, and the scope of protection is only limited by the scope of the accompanying claims.

I claim:

1. A device for assisting in transporting a disabled person comprising:
a compressed fluid cartridge;
an inflatable stretcher connected to said compressed fluid cartridge.

2. The device of claim 1 wherein said inflatable stretcher includes a first end, a second end opposing said first end, a first side and a second side opposing said first side.

3. The device of claim 2 wherein said stretcher, when inflated, has a generally rectangular profile.

4. The device of claim 2 further comprising a first handle connected on said first side of said stretcher, and a second handle connected to said second side of said stretcher.

5. The device of claim 2 further comprising a first handle connected at said first end of said stretcher, and a second handle connected at said second end of said stretcher.

6. The device of claim 2 further comprising a first belt for securing a disabled person to said stretcher.

7. The device of claim 6 further comprising a second belt for securing a disabled person to said stretcher.

8. The device of claim 2 wherein said stretcher includes a plurality of fluid containing pockets positioned from said first end to said second end of said stretcher.

9. The device of claim 8 wherein each of said pockets extend from said first side to said second side of said stretcher.

10. The device of claim 8 further comprising a fluid containing railing extending about said first end, first side, second end and second side.

11. The device of claim 2 wherein said stretcher includes an outer surface comprising a non-flammable material.

12. The device of claim 2 further comprising a plurality of wheels connected to a bottom portion of said stretcher.

13. The device of claim 1 wherein said fluid is air.

14. The device of claim 1 wherein said fluid is a non-flammable gas.

15. The device of claim 10 wherein said railing extends at least partially over a disabled person supported on said stretcher to secure and hold said person to said stretcher.

16. The device of claim 2 further including a sheet securable to said first side and said second side to secure and hold a disabled person to said stretcher.

17. The device of claim 2 further comprising an electronic beacon connected to said stretcher.

18. The device of claim 2 further comprising a compartment within said stretcher configured to support medical equipment.

19. The device of claim 2 further comprising a rigid support connected to a bottom portion of said stretcher.

20. The device of claim 19 wherein said rigid support is a sheet of hard plastic.

21. A device for carrying a disabled person comprising
an inflatable stretcher, said stretcher having a first end, a second end opposing said first end, a first side, a second side opposing said first side, a first handle connected proximate said first end, and a second handle connected proximate said second end.

22. The device of claim 21 wherein said stretcher further comprises a belt to secure a disabled person to said stretcher, said belt having a first belt portion connected to said first side of said stretcher, and a second belt portion to said second side of said stretcher.

23. The device of claim 21 wherein said stretcher comprises a plurality of pockets positioned between said first end and said second end, each said pocket extending from said first side to said second side of said stretcher.

24. The device of claim 21 including a compressed air cartridge connected to said stretcher to inflate said stretcher.

25. The device of claim 21 wherein said stretcher includes a first inflated railing portion at said first side extending from said first end to said second end, and a second inflated railing portion at said second side extending from said first end to said second end.

26. The device of claim 25 wherein said first and second railing portions extend to at least partially surround and enclose a disabled person positioned on said stretcher.

27. The device of claim 21 wherein said stretcher is formed of a flexible fire resistant material.

28. The device of claim 21 wherein said stretcher includes inflatable pockets proximate said second end to support and cushion a head portion of a disabled person.

29. The device of claim 21 further comprising a hard plastic sheet connected to a bottom portion of said stretcher.

30. The device of claim 21 wherein said stretcher includes a recessed portion when said stretcher is inflated to hold medical equipment for a disabled person.
